(19) United States
(12) Patent Application Publication
(10) Pub. No.: US 2008/0062558 A1
(43) Pub. Date: Mar. 13, 2008

(54) Automated Tape Library for Docking Within a Server Docking Station

(75) Inventors: Michael P. McIntosh, Tucson, AZ (US); Shawn M. Nave, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 11/531,150

(22) Filed: Sep. 12, 2006

(51) Int. Cl. G11B 15/00

(52) U.S. Cl. 360/90

(57) ABSTRACT

An automated tape library employs a docking frame structurally defining a tape storage workstation operable to be interlocked with one or more server slots of a server docking station for docking the automated tape library within the server docking station. The tape storage workstation houses a tape drive, one or more tape cartridge storage slots and a robotic picker. The tape cartridge storage slot(s) are used for storing one or more tape cartridges, and the robotic picker is used for moving the tape cartridge(s) between the tape drive and the tape cartridge storage slot(s).

### FIELD OF THE INVENTION

The present invention generally relates to automated tape libraries. The present invention specifically relates to automated tape libraries capable of being docked within a server docking station (e.g., a IBM BladeCenter® chassis).

### BACKGROUND OF THE INVENTION

A popular solution for IBM servers has been the IBM blade servers, which are long, wide, and thin (thus the name “blade”) and are capable of being docked within a IBM BladeCenter® chassis. Currently, the IBM BladeCenter® chassis is capable of holding up to fourteen (14) blade servers. One of the main benefits of this blade architecture is that there is no need for cables as each blade server can dock within the IBM BladeCenter® chassis without cables.

It has been found that the average IBM BladeCenter® chassis user only docks approximately five (5) blade servers within the IBM BladeCenter® chassis, which leaves many of the slots in the chassis open. Thus, these open slots could be used to put data storage that compliments the servers. This idea of docking storage devices within the IBM BladeCenter® chassis has been implemented in a storage blade, which uses disk storage and occupies three of the chassis slots. While the storage blade provides benefits to users of the IBM BladeCenter® chassis, additional storage solutions that fits into the blade architecture are needed.

### SUMMARY OF THE INVENTION

The present invention provides a new and unique automated tape library for server docking stations.

One form of the present invention is an automated tape library comprising a docking frame, a tape drive, one or more cartridge storage slots and a robotic picker. The docking frame structurally defines a storage workstation operable to be interlocked with at least one server slot of a server docking station for docking the automated tape library within the server docking station. The tape drive, the tape cartridge slot(s) and the robotic picker are disposed within the storage workstation. The tape cartridge storage slot(s) are for storing one or more tape cartridges, and the robotic picker is for moving the tape cartridge(s) between the tape drive and the tape cartridge storage slot(s).

The aforementioned forms and additional forms as well as objects and advantages of the present invention will become further apparent from the following detailed description of the various embodiments of the present invention read in conjunction with the accompanying drawings. The detailed description of the drawings are merely illustrative of the present invention rather than limiting, the scope of the present invention being defined by the appended claims and equivalents thereof.

### BRIEF DESCRIPTION OF THE DRAWINGS

FIG. 1 illustrates a front fully assembled isometric view of a first embodiment of an automated tape library in accordance with the present invention;

FIG. 2 illustrates a front partially assembled isometric view of the first embodiment of the automated tape library in accordance with the present invention;

FIG. 3 illustrates a rear fully assembled isometric view of the first embodiment of the automated tape library in accordance with the present invention;

FIG. 4 illustrates an isometric view of the first embodiment of the automated tape library of FIGS. 1-3 docked in accordance with the present invention within a server docking station as known in the art; and

FIGS. 5 and 6 illustrate side partially assembled isometric views of a second embodiment of an automated tape library in accordance with the present invention.

### DETAILED DESCRIPTION OF THE PRESENT INVENTION

The present invention is premised on providing an automated tape library that docks within a server docking station, such as, for example, the commercially available IBM BladeCenter® chassis.

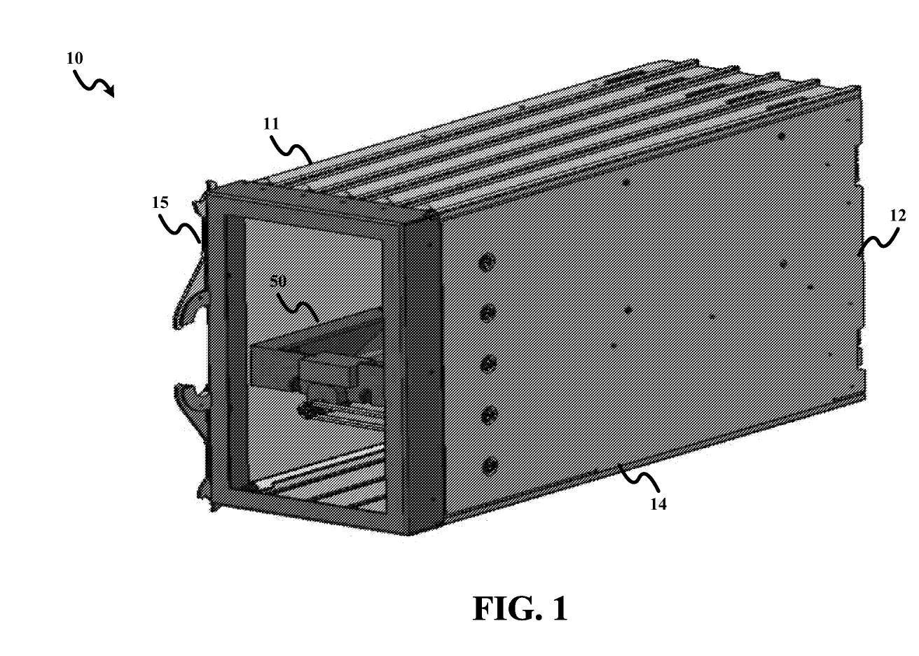

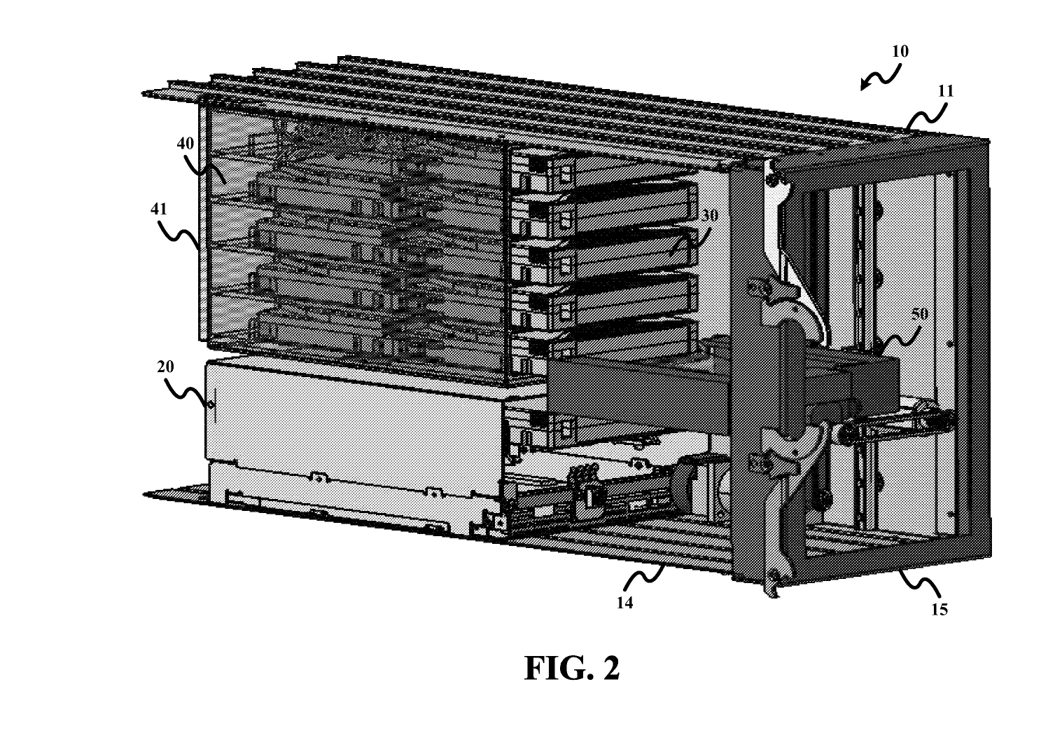

FIGS. 1-3 illustrates an automated tape library 10 having a docking frame including an integration of a ribbed top wall 11, a pair of side walls 12 and 13, a bottom rib wall 14 and a latched cover 15 to structurally define a storage workstation for docking library 10 within one or more server slots of a server docking station. As best shown in FIG. 2, the storage workstation contains a single LTO tape drive 20 and nine (9) LTO tape 30 cartridges using a two-deep tape cartridge arrangement of ten (10) tape cartridge storage slots 40. The maximum capacity of nine (9) tape cartridges 30 when ten (10) tape cartridge slots 40 are physically available allows for the tape cartridges 30 to be “shuffled” so that the rear tape cartridges in the two-deep slots can be reached by placing the front tape cartridge in the empty slot elsewhere in library 10. A spring mechanism (not shown) is used in the tape cartridge storage slots 40 to push the tape cartridge(s) 30 to the front of the slot so that a robotic picker 50, which is located in front of tape drive 20 and tape cartridges 30, can grab the tape cartridges 30 for movement to the tape drive 20 or another tape cartridge storage slot 40.

As best shown in FIG. 2, tape cartridges 30 are located vertically above the tape drive 20 due to space constraints and also to allow robotic picker 50 to only have two degrees of freedom. These degrees of freedom are vertical motion and a reach motion in order to grab or put away a tape cartridge 30. This arrangement allows for a simple and low cost robotic picker 50. Another feature of automated tape library 10 is that the tape cartridge storage slots 40 are defined by a removable magazine 41 that can be removed from automated tape library 10 for bulk loading or external storage.

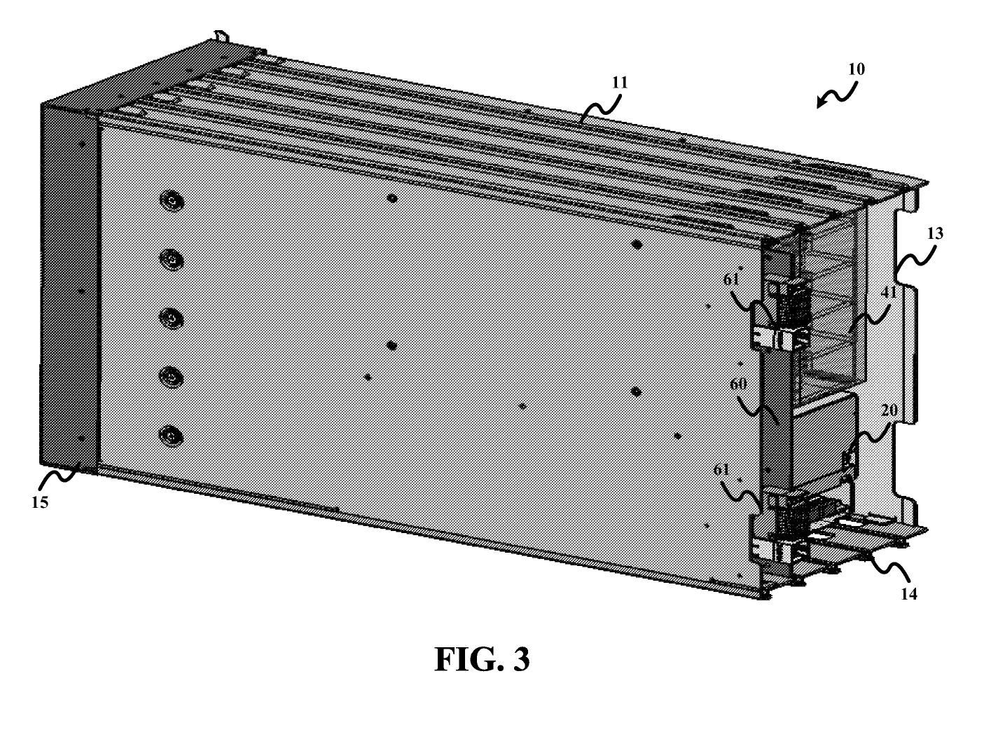

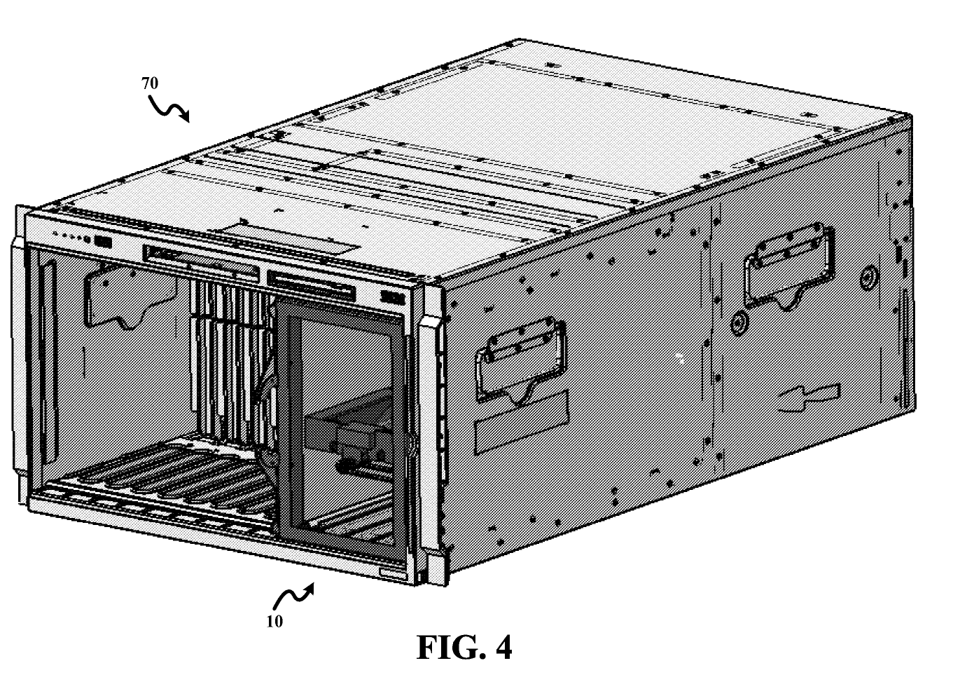

As best shown in FIG. 3, a control electronic circuit card 60 is available within the storage workstation along side tape drive 20 and tape cartridge storage magazine 41. Control electronic circuit card 60 is equipped with a pair of docking connectors 61, which in conjunction with the guiding ribs of walls 11 and 14, allow automated tape library 10 to be docked into in a server docking station as best shown in FIG. 4, and make electrical connections with a back plane located within the server docking station. The guiding ribs of walls 11 and 14 as well docking connectors 61 are compliant with the specifications of a server docking station to ensure proper docking of automated tape library 10 within the server docking station.

Those having ordinary skill in the art will appreciate the power supplies and cooling fans ordinarily needed in automated tape libraries are not present in an automated tape library of the present invention (e.g., library 10), because these functions are provided by the server docking station. This allows the cost of an automated tape library of the present invention to be very low in comparison to small autoloaders or libraries that could be used separate from a server docking station. Also, as with all of the blade devices, cables are not required.

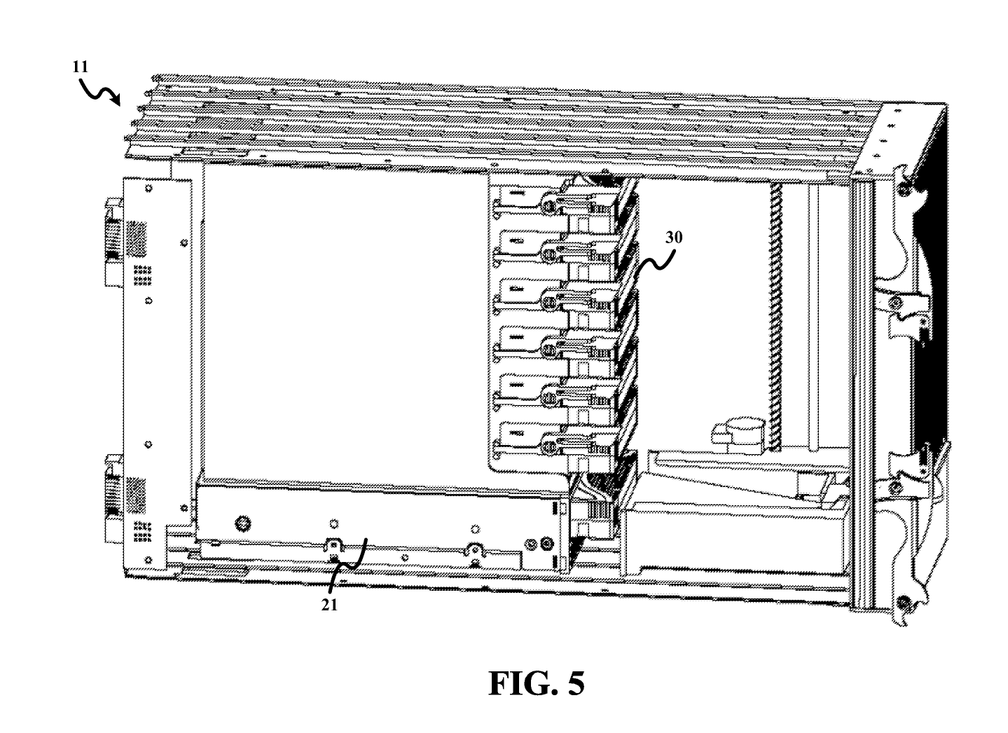

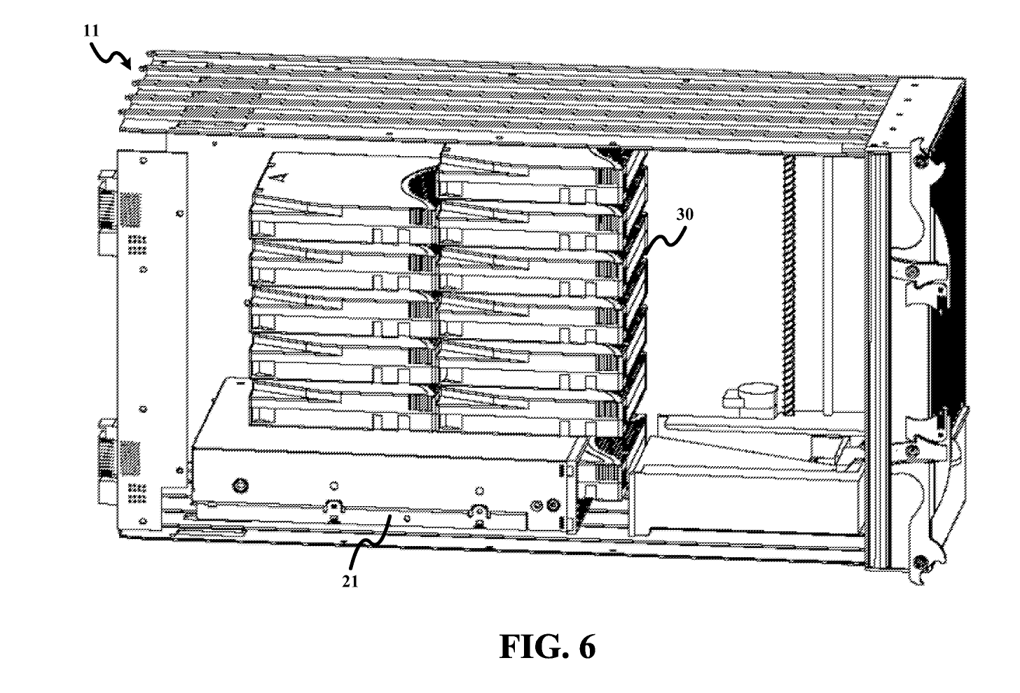

FIGS. 5 and 6 illustrate an automated tape library 11 of the present invention employing a half-high LTO tape drive 21 in lieu of tape drive 20 (FIGS. 2 and 3), which allows for more LTO cartridges 30 to be stored in the space above tape drive 21.

Furthermore, those having ordinary skill in the art may develop other embodiments of the present invention in view of the inventive principles of the present invention described herein. Thus, the terms and expression which have been employed in the foregoing specification are used herein as terms of description and not of limitations, and there is no intention in the use of such terms and expressions of excluding equivalents of the features shown and described or portions thereof, it being recognized that the scope of the present invention is defined and limited only by the claims which follow.

We claim:

1. An automated tape library, comprising:
a docking frame structurally defining a storage workstation operable to be interlocked with at least one server slot of a server docking station for docking the automated tape library within the server docking station;
a tape drive disposed within the storage workstation;
at least one tape cartridge storage slot disposed within the storage workstation, the at least one tape cartridge storage slot for storing at least one tape cartridge; and
a robotic picker disposed within the storage workstation, the robotic picker being operable to move the at least one tape cartridge between the tape drive and the at least one tape cartridge storage slot.

2. The automated tape library of claim 1, wherein the at least one tape cartridge slot is disposed over the tape drive within the storage workstation.

3. The automated tape library of claim 2, wherein the robotic picker is disposed adjacent the tape drive and the at least one tape cartridge within the storage workstation.

4. The automated tape library of claim 1,
wherein the robotic picker is disposed within a front section of the storage workstation; and
wherein the tape drive and the at least one tape cartridge storage slot are disposed in a rear section of the storage workstation.

5. The automated tape library of claim 1, further comprising:
a cartridge storage magazine disposed within the storage workstation, the cartridge storage magazine structurally defining the at least one cartridge storage slot.

6. The automated tape library of claim 5, wherein the cartridge storage magazine is removable from the storage workstation.

7. The automated tape library of claim 1, further comprising:
at least one control electronic circuit card disposed in the storage workstation, wherein the at least one control electronic circuit card is in electrical communication with the tape drive and the robotic driver.

8. The automated tape library of claim 7, further comprising:
at least one docking connector electrically coupled to the at least one control electronic circuit, wherein the at least one docking connector is operable to establish an electrical communication between the at least one control electronic circuit card and the server docking station based on the storage workstation being docked within the at least one server slot of the server docking station.

9. The automated tape library of claim 1, wherein the docking frame includes:
at least one ribbed wall for guiding the storage workstation into the at least one server slot of the server docking station.

10. The automated tape library of claim 1, wherein the docking frame includes:
a latched cover for physically moving the automated tape library within the at least one server slot of the server docking station.

11. An automated tape library, comprising:
a docking frame structurally defining a storage workstation operable to be interlocked with at least one server slot of a server docking station for docking the automated tape library within the server docking station;
at least one tape cartridge;
a tape drive disposed within the storage workstation;
at least one tape cartridge storage slot disposed within the storage workstation, the at least one tape cartridge storage slot for storing the at least one tape cartridge; and
a robotic picker disposed within the storage workstation, the robotic picker being operable to move the at least one tape cartridge between the tape drive and the at least one tape cartridge storage slot.

12. The automated tape library of claim 11, wherein the at least one tape cartridge slot is disposed over the tape drive within the storage workstation.

13. The automated tape library of claim 12, wherein the robotic picker is disposed adjacent the tape drive and the at least one tape cartridge within the storage workstation.

14. The automated tape library of claim 11,
wherein the robotic picker is disposed within a front section of the storage workstation; and
wherein the tape drive and the at least one tape cartridge storage slot are disposed in a rear section of the storage workstation.

15. The automated tape library of claim 11, further comprising:
a cartridge storage magazine disposed within the storage workstation, the cartridge storage magazine structurally defining the at least one cartridge storage slot.

16. The automated tape library of claim 15, wherein the cartridge storage magazine is removable from the storage workstation.

17. The automated tape library of claim 11, further comprising:
at least one control electronic circuit card disposed in the storage workstation, wherein the at least one control electronic circuit card is in electrical communication with the tape drive and the robotic driver.

18. The automated tape library of claim 17, further comprising:
at least one docking connector electrically coupled to the at least one control electronic circuit, wherein the at least one docking connector is operable to establish an electrical communication between the at least one control electronic circuit card and the server docking station based on the storage workstation being docked within the at least one server slot of the server docking station.

19. The automated tape library of claim 11, wherein the docking frame includes:
at least one ribbed wall for guiding the storage workstation into the at least one server slot of the server docking station.

20. The automated tape library of claim 11, wherein the docking frame includes:
a latched cover for physically moving the automated tape library within the at least one server slot of the server docking station.
